(19) United States
(12) Patent Application Publication
(10) Pub. No.: US 2012/0311328 A1
(43) Pub. Date: Dec. 6, 2012

(54) PROBE RESPONSE SUPPORTED WIRELESS AUTOCONNECTION

(75) Inventors: Zhifeng Wang, Beijing (CN); Jun Zhao, Beijing (CN); Edward Ding-Bong Un, Beijing (CN); Hua Li, Beijing (CN); Kaiyan Tian, Beijing (CN)

(73) Assignee: MICROSOFT CORPORATION, Redmond, WA (US)

(21) Appl. No.: 13/154,112

(22) Filed: Jun. 6, 2011

(51) Int. Cl. G06F 21/20; H04L 9/32

(52) U.S. Cl. 713/168; 726/3

(57) ABSTRACT

Computing devices can autoconnect to access points even if they have not previously received authentication information for those access points. A computing device broadcasts a probe request, comprising a request for authentication information. An access point receiving such a probe request generates a probe response that provides authentication information that the computing device can then utilize to establish a useful communication connection to the access point. The provided authentication information can be either encrypted or unencrypted, and can be encrypted for specific users or specific computing devices. Dedicated application programs can decrypt encrypted authentication information, thereby enabling autoconnecting, while also delivering targeted information to users of the autoconnecting computing devices from a retailer hosting the access point. Authentication information for a “landing page” can be provided to a web browser to enable autoconnection.

### BACKGROUND

Most modern computing devices, including desktop computing devices, laptop computing devices, tablet computing devices, hand-held computing devices, and cellular computing devices comprise wireless communication capabilities. Because of this ubiquity of wireless communication capabilities, wireless networks are broadly available. For example, most offices, homes, retail establishments, dining establishments and hotel establishments utilize some form of wireless networking. As a result, users have become accustomed to maintaining a wireless connection to broader networks of computing devices, such as the ubiquitous Internet and World Wide Web.

Many users own or utilize multiple computing devices that comprise wireless communication capabilities. For example, a user may own and utilize both a laptop computing device and a cellular computing device, each of which, independently, comprises wireless configuration capabilities. Additionally, many users utilize such computing devices to communicate with a myriad of wireless networks. For example, a user can communicationally couple a computing device with wireless communication capabilities to wireless networks provided by that user's place of employment, that user's home, and other retail, dining, or hotel establishments that the user may visit. As a result, users are typically forced to provide authentication information many times, even though computing devices often comprise computer-executable instructions that remember authentication information for specific wireless networks to which that computing device has been previously communicationally coupled.

A user with, for example, a cellular computing device that comprises wireless communication capabilities can have that device automatically establish a wireless communication connection with wireless networks to which the user is typically exposed. For wireless networks at such a user's home or place of business, that cellular computing device has likely been communicationally coupled with those wireless networks previously and, as such, can store and recall the authentication information necessary to authenticate to, and communicationally couple with, those wireless networks. However, for wireless networks to which such a cellular computing device has not previously been coupled, such as a wireless network at a coffee shop that that user may be visiting, the user would be required to manually enter authentication information into the cellular computing device before the cellular computing device could be usefully communicationally coupled with the wireless network. If the user were traveling with both the cellular computing device, and a laptop computing device, the user could be required to manually enter authentication information into both such computing devices in order to usefully communicationally couple those devices with the wireless network being offered by, for example, the coffee shop that the user may be visiting. Should that same user then travel to a retail establishment that, likewise, maintains its own wireless network, the user can be required, again, to manually enter authentication information into two different computing devices in order to communicationally couple those devices with the wireless network of, for example, now the retail establishment that the user is visiting.

### SUMMARY

In one embodiment, upon identifying at least one wireless access point, a computing device with wireless communication capabilities can broadcast a probe request that can include a request for authentication information. Upon receiving such a probe request, a wireless access point can respond with a probe response that includes the requested authentication information. The computing device receiving such a probe response can obtain the authentication information from it, and present it to the wireless access point in order to be authenticated to the wireless access point and, thereby, join, the wireless network. From the perspective of a user of such a computing device, the computing device can become communicationally coupled with the access point, enabling the user to utilize the wireless network, without the user having to provide any authentication information, even if the computing device, or the user, has not previously joined that wireless network.

In another embodiment, the authentication information provided by the access point in the probe response can either be encrypted or unencrypted. If it is unencrypted, then any computing device, with wireless communication capabilities, that receives such a probe response and comprises relevant computer-executable instructions for recognizing the authentication information provided by the probe response, can be authenticated to the wireless access point and, thereby, can autoconnect to the wireless network. Alternatively, if the authentication information provided in the probe response is encrypted, then only those computing devices, or those users, with the relevant decryption information can access the authentication information, be authenticated to the wireless access point therewith, and, thereby, autoconnect to the wireless network.

In a further embodiment, the authentication information provided by an access point in a probe response can be encrypted such that it can be decrypted either by decryption information that is specific to a personal computing device, or decryption information that is specific to a user. If access to the wireless network were to be limited to specific individuals, the authentication information provided by an access point in a probe response could be encrypted utilizing the public key, or other cryptographic information, that would be unique to those specific individuals, thereby providing that only those specific individuals could autoconnect to the network. Alternatively, access to the wireless network could be limited to specific computing devices, such as computing devices that comprise an application program designed to autoconnect to the wireless network. Such an application program, in addition to autoconnecting to the wireless network, can also provide information or services that can be relevant to the entity hosting the wireless network, including advertising services for retail establishments hosting the wireless network.

In a still further embodiment, the authentication information provided by an access point in a probe response can comprise authentication information to be entered into a “landing page” such as is typically utilized to authenticate users to a public wireless network. In such an embodiment, computer-executable instructions executing on a computing device comprising a wireless communication capability can obtain the authentication information from the probe response and can provide it to a web browser, or other relevant application program executing on the computing device, to enable the automatic entry of such authentication information into a “landing page”, thereby providing for autoconnection to the wireless network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary autoconnection communicational exchange;

FIG. 2 is a block diagram of an exemplary probe request and response;

FIG. 3 is a flow diagram of an exemplary autoconnection;

FIG. 4 is a flow diagram of an exemplary probe response generation; and

FIG. 5 is a block diagram of an exemplary computing device.

### DETAILED DESCRIPTION

The following description relates to mechanisms for automatically establishing a useful communicational connection between a personal computing device and an access point such that the personal computing device can communicate with one or more other computing devices connected to a network through the access point. The personal computing device can broadcast a probe request, comprising a request for authentication information, to one or more access points. An access point receiving such a probe request can generate a probe response that provides authentication information that the computing device can then utilize to establish a useful communication connection between it and the access point. The provided authentication information can be unencrypted, thereby enabling any computing device, comprising the relevant computer-executable instructions for obtaining such authentication information from the probe response, to establish a useful communication connection with the access point. Alternatively, the provided authentication information can be encrypted, either for specific users or specific computing devices. Authentication information encrypted for specific users can be decrypted by computing devices comprising those users' credentials, while authentication information encrypted for specific computing devices can be decrypted by computing devices comprising relevant computer-executable instructions for decrypting such authentication information. Those relevant computer-executable instructions can further be utilized to provide information or services that are relevant to the entity hosting the access point. Authentication information can comprise information relevant to a “landing page”, which can be provided to an application program, such as a web browser, to enable the autoconnection.

For purposes of illustration, the techniques described herein make reference to wireless networks, but such references are strictly exemplary and are not intended to limit the mechanisms described to only wireless networks. Indeed, the techniques described are equally applicable to any network communicational connection, whether wired or wireless. Additionally, for purposes of illustration, the techniques described herein make reference to wireless networks that are utilized to provide a communicational connection to a further, broader, network of computing devices, such as the ubiquitous Internet or World Wide Web. However, the techniques described are not limited to Internet connectivity and are equally applicable to the communications, through an access point, to any one or more other computing devices and local area, or wide area, networks thereof.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

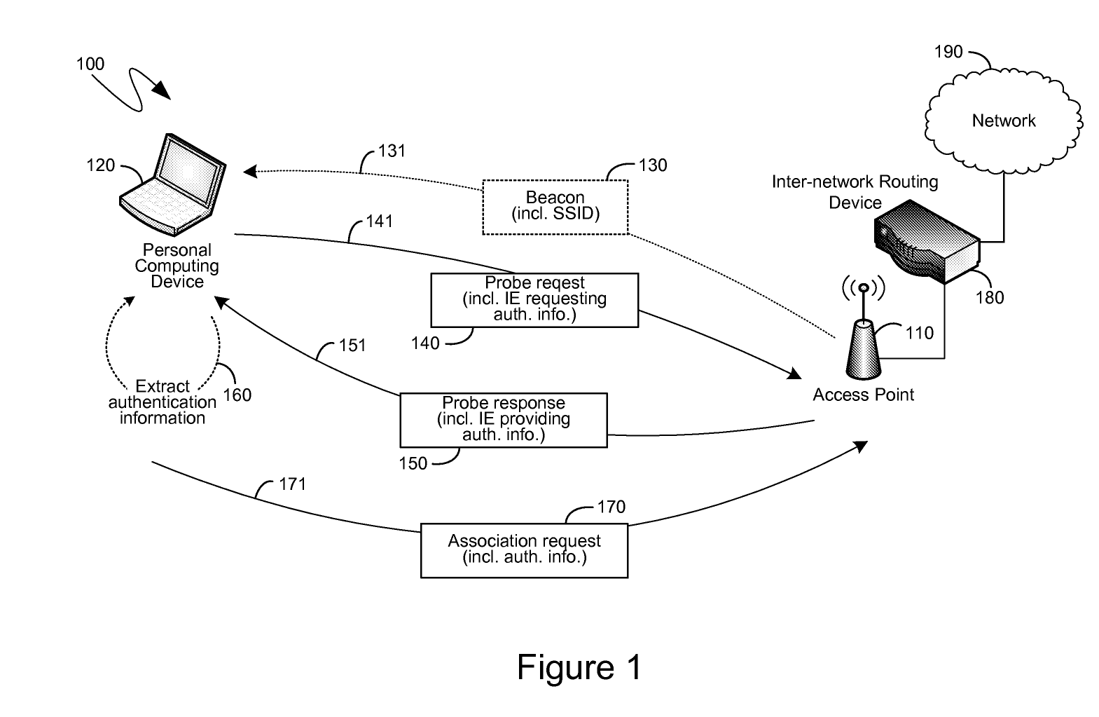

Turning to FIG. 1, a system 100 is shown, comprising a personal computing device 120 and an access point 110. For purposes of illustration, the personal computing device 120 is shown in the form of a laptop computing device. However, as will be recognized by those skilled in the art, the descriptions below are equally applicable to any form of computing device, including desktop computing devices, handheld computing devices and cellular computing devices, that comprise the relevant communicational capabilities for generating, transmitting, receiving and deciphering the below described messages and otherwise performing the below described mechanisms. Similarly, for purposes of illustration, the access point 110 is shown in the form of a dedicated hardware component, such as a dedicated wireless base station. However, as will also be recognized by those skilled in the art, the descriptions below are equally applicable to any type of computing device that provides access point functionality, whether a specialized computing device, such as the dedicated wireless base station illustrated, or a more general purpose computing device, such as a general purpose computing device executing computer-executable instructions for providing access point functionality.

Typically, although not required by any of the mechanisms described below, the access point 110 is communicationally coupled to a network 190, such as through an inter-network routing device 180. For example, the network 190 is often, though not always, the Internet or another like large distributed network. Similarly, the inter-network routing device 180 is often, though again not always, a modem, such as a cable modem, a Digital Subscriber Line (DSL) modem, or like modem, that communicationally couples the access point 110 to the network 190, such as through a network service provider. Thus, for purposes of providing context for the descriptions below, the personal computing device 120 can seek to access one or more of the computing devices that are part of the network 190 and, as such, the personal computing device 120 can seek to establish a communicational connection with the access point 110 such that the personal computing device 120 can send communications through the access point 110 and the inter-network routing device 180 to the one or more computing devices that are part of the network 190 with which the personal computing device 120 wishes to communicate. In the descriptions below, reference will be made to a “useful” communicational connection between the personal computing device 120 and the access point 110. In such a context, the term “useful” means a communicational connection that can enable the personal computing device 120 to communicate with other computing devices through the access point 110, such as the computing devices that comprise the network 190, as opposed to merely the maintenance communicational connection that can exist between the personal computing device 120 and the access point 110 that terminates with the access point 110 and is not routed to other computing devices, such as via the inter-network routing device 180.

Initially, in one embodiment, the access point 110 can transmit signals comprising a beacon 130. Such signals can be received by the personal computing device 120, such as via the communication 131 shown in the system 100 of FIG. 1. As will be recognized by those skilled in the art, the beacon 130 typically comprises some form of identifier of the access point 110, such as a Service Set IDentifier (SSID).

When the personal computing device 120 detects the access point 110, such as by receiving the communication 131 comprising the beacon 130, computer-executable instructions executing on the personal computing device 120 can generate and transmit a probe request 140 to the access point 110. In one embodiment, probe requests, such as the probe request 140, are broadcast by the personal computing device 120 such that any access point within communicational range of the personal computing device 120 can receive such probe requests. For purposes of illustration, however, a single access point, namely the access point 110, is illustrated in the system 100 of FIG. 1, and the probe request 140, generated by the personal computing device 120, is shown as being communicationally delivered to the access point 110 via the communication 141.

As indicated, the transmission of the probe request 140, such as via the communication 141, can be based on the personal computing device 120 detecting the access point 110. In one embodiment, such a detection can be based on receiving a beacon 130, such as that sent via the communication 131. However, in other embodiments, the personal computing device 120 can detect the access point 110 through other mechanisms separate and apart from the beacon 130. For example, the personal computing device 120 can detect the access point 110 by receiving a probe response, such as that described in detail below, that is sent by the access point 110 in response to a probe request 140 that was sent by another, different computing device that is communicating with the same access point 110 as the personal computing device 120. Consequently, the beacon 130 and the corresponding communication 131 are illustrated, in the system 100 of FIG. 1, with dashed lines to indicate that they represent an optional aspect of the communications and mechanisms described herein.

In one embodiment, the probe request 140 can comprise a request for authentication information, specifically the information necessary to authenticate the personal computing device 120 with the access point 110, thereby establishing a useful communicational connection between the personal computing device 120 and the access point 110, and thereby enabling the personal computing device 120 to communicate with one or more other computing devices, such as those that can be part of the network 190, through the access point 110. More specifically, the probe request 140 can comprise information elements, referred to as “IE” in the system 100 of FIG. 1, in which the request for authentication information can be transmitted. Typically, such information elements are reserved portions of an otherwise standardized request that can be utilized for transmitting an information payload, such as, in the present embodiment, a request for authentication information.

Upon receiving the probe request 140, such as via the communication 141, from the personal computing device 120, the access point 110 can respond to the personal computing device 120 with a probe response 150. In one embodiment, although not specifically illustrated in the system 100 of FIG. 1, the access point 110 can perform one or more checks prior to transmitting the probe response 150. For example, the access point 110 can verify the integrity of the probe request 140, such as in a manner well known to those skilled in the art, and typically provided for by various communicational standards, such as can be implemented by the personal computing device 120 and the access point 110 to facilitate the communications described herein. As another example, the access point 110 can perform some checking of the personal computing device 120, such as, for example, by verifying that the personal computing device 120 is not on a blacklist, or otherwise not allowed to attempt to authenticate to the access point 110. In such an embodiment, the probe request 140, provided by the personal computing device 120, can comprise additional information in addition to the request for the authentication information. For example, the probe request 140 can comprise an identifier of the personal computing device 120, such as a Media Access Control (MAC) address, which can then be utilized by the access point 110 to verify that it can proceed with further communications with the personal computing device 120.

In response to receiving the probe request 140, and assuming that any checks that were performed were deemed to have been acceptable, computer-executable instructions executing on the access point 110 can generate and transmit a probe response 150, such as via the communication 151, to the personal computing device 120. In one embodiment, the probe response 150 can provide the authentication information that can then be utilized by the personal computing device 120 to authenticate itself to the access point 110, namely the authentication information that was requested by the personal computing device 120 via the probe request 140. As before, the provided authentication information can be provided in information elements that can be part of a standardized probe response structure, and which provide the mechanism by which the probe response structure can be utilized to convey data.

Upon receiving the probe response 150, such as via the communication 151, from the access point 110, computer-executable instructions executing on the personal computing device 120 can extract the authentication information provided within the probe response 150, as illustrated by the extraction operation 160 shown in the system 100 of FIG. 1. In one embodiment, the extraction operation 160 can comprise obtaining unencrypted authentication information from an appropriate information element of the probe response 150. In an alternative embodiment, however, the extraction operation 160 can comprise not only obtaining encrypted authentication information from an appropriate information element of the probe response 150, but it can further comprise decrypting that encrypted authentication information.

As indicated previously, in one embodiment, the authentication information can be encrypted in such a manner that it can be decrypted by specific users. For example, the authentication information can be encrypted with a specific user's public key. In such an embodiment, the extraction operation 160 can further comprise obtaining a user's private key, or other such decryption information that can be specific to that user, and with that obtained decryption information, decrypting the encrypted authentication information provided in the probe response 150. As such, the extraction operation 160 can comprise a request to the user of the personal computing device 120 to provide the necessary, user specific, decryption information, such as via a graphical user interface of the personal computing device 120. Alternatively, the extraction operation 160 can comprise accessing a certificate store, or other like repository of cryptographic information on the personal computing device 120 that can be specific to the user of the personal computing device 120, and utilizing such information to decrypt the authentication information provided in the probe response 150.

In an alternative embodiment, the authentication information can be encrypted in such a manner that it can be decrypted by specific computing devices. For example, the authentication information can be encrypted such that it can only be decrypted by those computing devices that are executing an application program, or one or more other collections of computer-executable instructions, that have access to a specific key, or other decryption information. Such application programs can be designed, as will be described further below, to provide additional functionality or features that can be relevant to the entity that is hosting the access point 110 and is, thereby, providing the personal computing device 120 with the communicational coupling to the network 190. In such an embodiment, the extraction operation 160 can comprise interfacing with such application programs in order to obtain the specific key, or other decryption information, or otherwise provide the encrypted authentication information to such application programs, so as to decrypt the authentication information.

Once the extraction operation 160 has completed, the personal computing device 120 can transmit an association request 170 to the access point 110, such as via the communication 171, in order to usefully communicationally couple the personal computing device 120 to the access point 110, and enable the personal computing device 120 to communicate through the access point 110 to further computing devices, such as those that are part of the network 190. As will be recognized by those skilled in the art, the association request 170 can be in conformance with whatever communicational standards are being implemented by the personal computing device 120 and the access point 110. Additionally, the association request 170 can comprise the authentication information necessary to enable the personal computing device 120 to establish a useful communicational connection with the access point 110. In the above-described embodiments, the authentication information provided as part of the association request 170 can be the same authentication information that was received, from the access point 110, of the probe response 150, and was extracted via the extraction operation 160. In such a manner, the personal computing device 120 can autoconnect to the access point 110, enabling a user of the personal computing device 120 to access features and services offered by one or more computing devices that are part of the network 190, without requiring that user to manually provide the authentication information, either in the present communicational instance, or in some prior communicational instance between the personal computing device 120 and the access point 110.

In many instances, the above-described mechanisms can be implemented in contexts where the personal computing device 120 is establishing only a temporary communicational connection with the access point 110, rather than, for example, a more permanent communicational connection such as might be established between a computing device and an access point at a user's home or place of business. For example, the access point 110 can be provided by a retail establishment that can advertise, or otherwise monetarily benefit from enabling its customers to communicationally couple to the network 190. In one embodiment, such a retail establishment can provide a dedicated application program, or other collection of computer-executable instructions, that users can install on various computing devices, such as the personal computing device 120. Such an application program can provide necessary cryptographic information to enable a computing device, such as the personal computing device 120, to decrypt authentication information provided by an access point, such as the access point 110, that can be provided by that retail establishment, thereby enabling users of that computing device to access the network 190 through the access point provided by that retail establishment. In one embodiment, such a dedicated application program can further provide advertising, or other service features or functionality that can be relevant to the retail establishment providing the access point. For example, such an application program can advertise products or services that such a retail establishment may wish to sell to the user, or it can provide the user with discounts or other incentives that can be offered by the retail establishment to entice the user to provide additional revenue to the retail establishment.

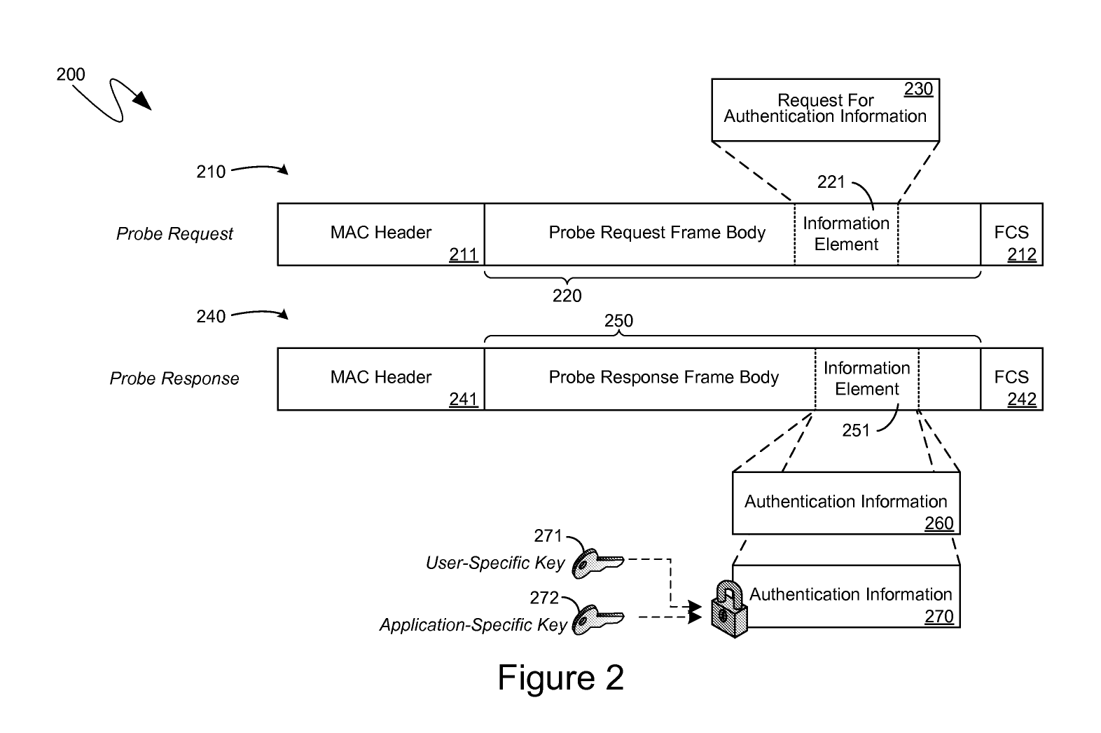

Turning to FIG. 2, the system 200 shown therein illustrates an exemplary probe request 210 and an exemplary probe response 240 in accordance with one commonly utilized communicational protocol. The probe request 210 can be transmitted in the form of one or more “frames”, such as that illustrated by the system 200 of FIG. 2. More specifically, the probe request 210 can comprise a Media Access Control (MAC) header 211, a probe request frame body 220, and a Frame Check Sequence (FCS) 212 or other like data utilized to verify the integrity of the overall probe request 210. In one embodiment, the probe request frame body 220 can conform to communicational protocol standards that provide for defined information to be included at defined locations within the probe request frame body 220. In such an embodiment, the communicational protocol standards can provide for one or more information elements, such as the information element 221, that can comprise what is known as “vendor-specific information”, or otherwise information that is not defined by, or required by the communicational protocol standard. Thus, in such an embodiment, at least one information element of the probe request 210, such as the information element 221, can comprise the request for authentication information 230, such as was described previously.

Similarly, the probe response 240 can, likewise, be transmitted in the form of one or more frames, such as that illustrated by the system 200 of FIG. 2. In accordance with relevant communicational protocol standards, the probe response 240 can comprise a MAC header 241, a probe response frame body 250, and a FCS 242 or other like data utilized to verify the integrity of the overall probe response 240. As in the case of the probe request, relevant communicational protocol standards can define certain aspects of the probe response frame body 250, while likewise allowing for information elements, such as the element 251, that can comprise data that is not specifically required by, or defined by, the protocol standard. As shown in the system 200 of FIG. 2, one or more information elements of the probe response 240, such as the information element 251, can comprise either unencrypted authentication information 260, or encrypted authentication information 270. As indicated previously, and as also illustrated by the system 200 of FIG. 2, the encrypted authentication information 270 can either be encrypted such that it can be decrypted by a user-specific key, such as the user-specific key 271, or such that it can be decrypted by an application-specific key, such as the application-specific key 272. Requiring a user-specific key, such as the user-specific key 271, to decrypt the encrypted authentication information 270 can, as will be recognized by those skilled in the art, limit the above described autoconnection capabilities to a defined group of one or more users. Conversely, requiring an application-specific key, such as the application-specific key 272, to decrypt the encrypted authentication information 270 can limit the above described autoconnection capabilities to those computing devices that are executing the required application program, thereby, provide for a content delivery mechanism that can be utilized by, for example, a retail establishment hosting an autoconnection-capable access point.

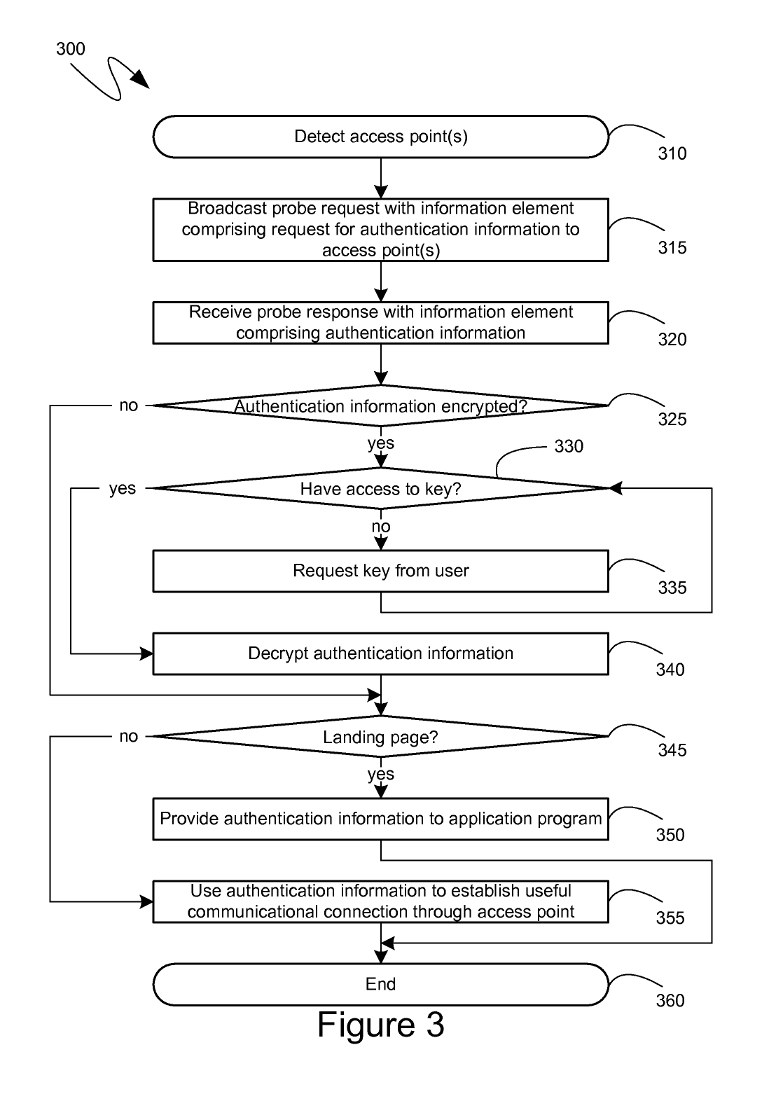

Turning to FIG. 3, the flow diagram 300 shown therein illustrates an exemplary series of steps that can be performed, such as by computing device seeking to communicationally couple to an access point, to enable communications through the access point to further computing devices. Initially, as illustrated, at step 310, one or more access points can be detected. As will be recognized by those skilled in the art, the access points can be detected, at step 310, by receiving one or more beacons. As will also be recognized by those skilled in the art, and as explicitly described previously, other mechanisms can be employed, at step 310, to detect one or more access points. For example, one or more other probe responses, directed to other computing devices, or other like broadcast signals from the one or more access points can be detected and the one or more access points can, thereby, be detected, as indicated at step 310. Once at least one access point is detected, at step 310, processing can proceed with step 315, at which point a probe request with an information element comprising a request for authentication information can be broadcast. The broadcast of the probe request, at step 315, can either be to all of the access points detected at step 310, or can comprise identifying information to indicate its applicability to only a selected subset thereof.

At step 320, in response to the probe request that was broadcast at step 315, one or more probe responses can be received that can comprise information elements that, in turn, comprise requested authentication information. At step 325, a determination can be made as to whether the authentication information, that was received as part of the probe response at step 320, is encrypted. If, at step 325, it is determined that the authentication information that was received at step 320 is, in fact, encrypted, then processing can proceed to step 330, at which point a further determination can be made as to whether a key, or other like cryptographic information necessary to decrypt the encrypted authentication information, can be obtained. For example, a key necessary to decrypt the encrypted authentication information can be obtained from a certificate store on the computing device, or from a dedicated application program, or other like collection of computer-executable instructions, that can provide such a key. If, at step 330, it is determined that a key is not available to decrypt the encrypted authentication information, the user can be requested, such as through a user interface, at step 335, to provide the key, or otherwise terminate the autoconnection. However, if, at step 330, it is determined that a key to decrypt the encrypted authentication information can be obtained, then, at step 340, such a key can be obtained and the encrypted authentication information can be decrypted.

Subsequently, at step 345, a determination can be made as to whether the access point requires a “landing page” or other like mechanism through which authentication is to be performed, or is otherwise a part of the authentication process. For example, as will be known by those skilled in the art, access points can often require a user to authenticate, or otherwise agree to terms and conditions, by displaying a page prior to allowing the user access to a further network of computing devices. In one common implementation, such a landing page is in the form of an HTML webpage that is displayed on a user's web browser when the user attempts to utilize that web browser to establish communicational connection with one or more computing devices on a network through the access point.

Thus, if, at step 345, it is determined that the access point has presented a landing page, such as for the collection of authentication information, then, at step 350, the authentication information can be provided to an application program, such as a web browser, that can provide such authentication information, via the landing page, to the access point. The autoconnection can then succeed, and relevant processing can end at step 360. If, however, at step 345, it is determined that there is no landing page being presented by the access point, then processing can proceed to step 355 where the obtained authentication information can be utilized to establish a useful communicational connection to the access point, such as in a traditional manner whereby the authentication information is presented to the access point to authenticate the computing device and enable it to communicate to other computing devices through the access point. Again, having autoconnected to the access point, the relevant processing can end at step 360.

Returning back to step 325, if it is determined, at step 325, that the authentication information is not encrypted, then access to the authentication information can be obtained without resort to cryptographic processes, and processing can skip to step 345 and proceed from there, such as in the manner described in detail above.

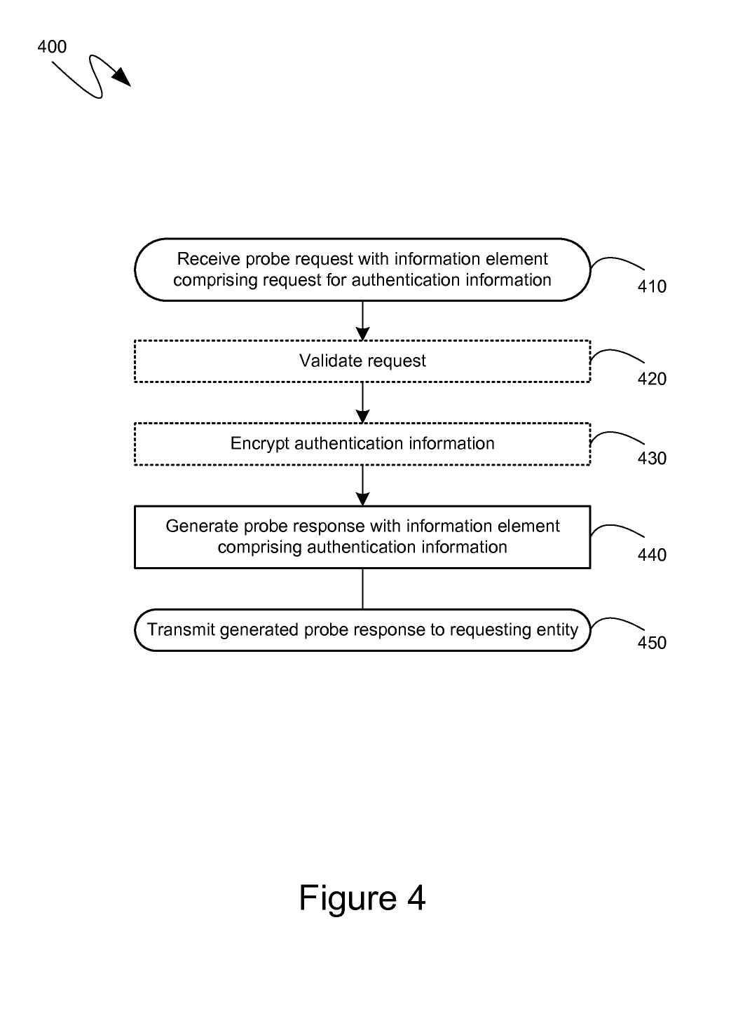

Turning to FIG. 4, the flow diagram 400 shown therein illustrates an exemplary series of steps that can be performed, such as by an access point, to provide for autoconnection capabilities. Initially, as shown, at step 410, a probe request can be received from a computing device seeking to establish a useful communicational connection with the access point. As indicated previously, the probe request received at step 410 can comprise an information element that can further comprise a request for authentication information. At step 420, the access point can, optionally, validate such a request such as, for example, by ensuring that the computing device making the request is not on a blacklist or is otherwise prohibited from making such a request or communicationally coupling with the access point. Step 420 is illustrated with a dashed border in FIG. 4 to illustrate that it is an optional step.

At step 430, the requested authentication information can be optionally encrypted to limit autoconnection to selected devices, or a selected group of one or more users. As indicated previously, if the access point seeks to limit autoconnection to selected devices, it can encrypt the authentication information, at step 430, in such a manner that it can be decrypted only by those devices comprising the necessary decryption information, such as a key that can be embedded into an application program that, in turn, can act as a vehicle that a provider of the access point can utilize to communicate with end-users. Likewise, as also indicated previously, if the access point seeks to limit autoconnection to a selected group of one or more users, it can encrypt the authentication information, at step 430, in such a manner that it can be decrypted only by decryption information that is unique to the users of the selected group, such as, for example, private keys of those users. As in the case of step 420, step 430 is illustrated in FIG. 4 with a dashed border to indicate that it is an optional step.

At step 440, a probe response with an information element that includes the authentication information that was generated previously can be created and, at step 450, the relevant processing on the part of the access point can end with the transmission of that generated probe response to the requesting computing device.

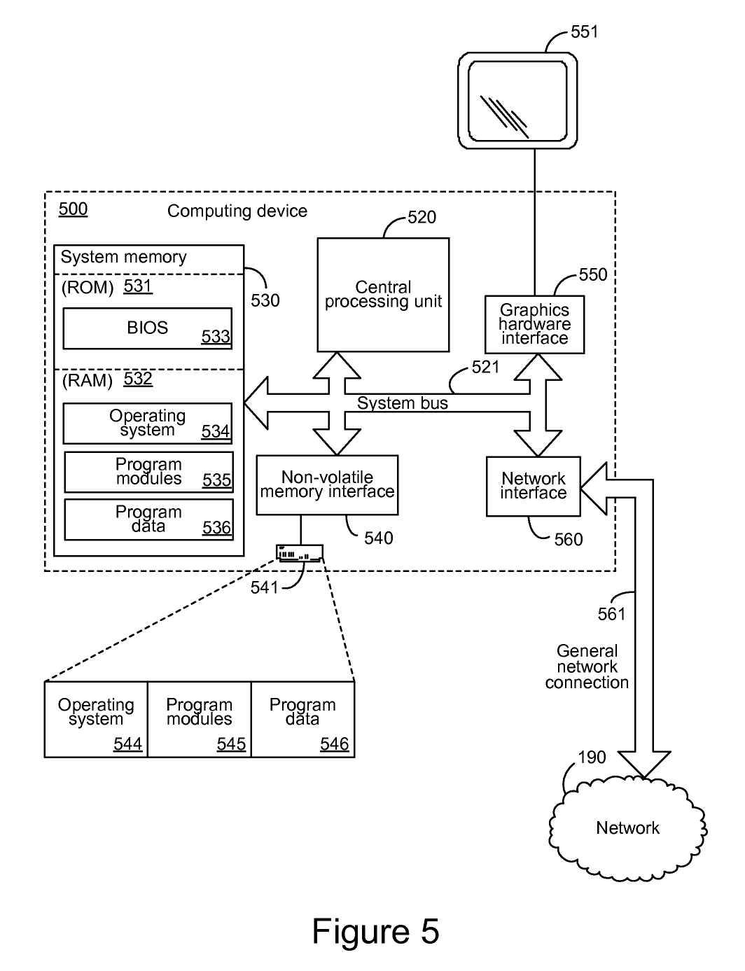

Turning to FIG. 5, an exemplary computing device 500 is illustrated. The exemplary computing device 500 can be any one or more of the computing devices illustrated in FIG. 1, including general purpose computing devices, such as the personal computing device 120 shown in FIG. 1, and also including dedicated computing devices, such as the access point 110, also shown in FIG. 1, both of whose operation was described in detail above. The exemplary computing device 500 of FIG. 5 can include, but is not limited to, one or more central processing units (CPUs) 520, a system memory 530, that can include RAM 532, and a system bus 521 that couples various system components including the system memory to the processing unit 520. The system bus 521 may be any of several types of bus structures including a memory bus or memory controller, a peripheral bus, and a local bus using any of a variety of bus architectures. The computing device 500 can optionally include graphics hardware, such as for the display of a user interface, especially within the case of a general purpose computing device. Dedicated computing devices, such as an access point, may not comprise a display 551, per se, but they often comprise other visual user feedback hardware, such as Light Emitting Diodes (LEDs) and the like. The graphics hardware can include, but is not limited to, a graphics hardware interface 550 and a display device 551. Depending on the specific physical implementation, one or more of the CPUs 520, the system memory 530 and other components of the computing device 500 can be physically co-located, such as on a single chip. In such a case, some or all of the system bus 521 can be nothing more than silicon pathways within a single chip structure and its illustration in FIG. 5 can be nothing more than notational convenience for the purpose of illustration.

The computing device 500 also typically includes computer readable media, which can include any available media that can be accessed by computing device 500 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 500. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 530 includes computer storage media in the form of volatile and/or nonvolatile memory such as read only memory (ROM) 531 and the aforementioned RAM 532. A basic input/output system 533 (BIOS), containing the basic routines that help to transfer information between elements within computing device 500, such as during start-up, is typically stored in ROM 531. RAM 532 typically contains data and/or program modules that are immediately accessible to and/or presently being operated on by processing unit 520. By way of example, and not limitation, FIG. 5 illustrates the operating system 534 along with other program modules 535, and program data 536. As will be recognized by those skilled in the art, in dedicated computing devices, a single cohesive set of computer-executable instructions directed to the performance of the tasks to which the dedicated computing device is dedicated can comprise the operating system 534 and the program modules 535 and program data 536.

The computing device 500 may also include other removable/non-removable, volatile/nonvolatile computer storage media. By way of example only, FIG. 5 illustrates the hard disk drive 541 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540.

The drives and their associated computer storage media discussed above and illustrated in FIG. 5, provide storage of computer readable instructions, data structures, program modules and other data for the computing device 500. In FIG. 5, for example, hard disk drive 541 is illustrated as storing operating system 544, other program modules 545, and program data 546. Note that these components can either be the same as or different from operating system 534, other program modules 535 and program data 536. Operating system 544, other program modules 545 and program data 546 are given different numbers hereto illustrate that, at a minimum, they are different copies.

The computing device 500 can operate in a networked environment using logical connections to one or more remote computers. The computing device 500 is illustrated as being connected to a general network connection 561 through a network interface or adapter 560 that is, in turn, connected to the system bus 521. In a networked environment, program modules depicted relative to the computing device 500, or portions or peripherals thereof, may be stored in the memory of one or more other computing devices that are communicatively coupled to the computing device 500 through the general network connection 561. It will be appreciated that the network connections shown are exemplary and other means of establishing a communications link between computing devices may be used.

As can be seen from the above descriptions, mechanisms for autoconnecting to an access point have been enumerated. In view of the many possible variations of the subject matter described herein, we claim as our invention all such embodiments as may come within the scope of the following claims and equivalents thereto.

We claim:

1. One or more computer-readable media comprising computer-executable instructions for autoconnecting to an access point, the computer-executable instructions performing steps comprising:
generating a probe request comprising a request for authentication information;
transmitting the generated probe request in response to detecting the access point;
receiving, from the access point, a probe response, in response to the transmitting the generated probe request, the received probe response comprising authentication information associated with the access point;
generating a request to establish a useful communicational connection with the access point, the useful communication connection providing for communications with other computing devices through the access point, the generated request comprising the authentication information associated with the access point from the received probe response; and
transmitting the generated request to the access point.

2. The computer-readable media of claim 1, wherein the generated probe request comprises at least one information element, the at least one information element of the generated probe request comprising the request for authentication information; and wherein further the received probe response also comprises at least one information element, the at least one information element of the received probe response comprising the authentication information associated with the access point.

3. The computer-readable media of claim 2, wherein the detecting the access point comprises receiving another probe response from the access point, the other probe response being in response to another probe request that was transmitted by another computing device; and wherein further the computer-executable instructions for transmitting the generated probe request comprise computer-executable instructions for broadcasting the generated probe request.

4. The computer-readable media of claim 1, comprising further computer-executable instructions for decrypting encrypted authentication information associated with the access point; wherein the authentication information associated with the access point from the received probe response comprises the encrypted authentication information associated with the access point.

5. The computer-readable media of claim 4, comprising further computer-executable instructions for obtaining user-specific decryption information, for performing the decrypting the encrypted authentication information associated with the access point, from a local certificate store.

6. The computer-readable media of claim 4, comprising further computer-executable instructions for obtaining decryption information, for performing the decrypting the encrypted authentication information associated with the access point, from an application program executing on a same computing device as the computer-executable instructions.

7. The computer-readable media of claim 6, wherein the application program provides advertising on behalf of a retailer hosting the access point.

8. The computer-readable media of claim 1, comprising further computer-executable instructions for providing the authentication information associated with the access point to a web browser; wherein the generating the request to establish the useful communicational connection and the transmitting the generated request are performed by the web browser in communication with a landing page.

9. One or more computer-readable media comprising computer-executable instructions for enabling a computing device to autoconnect to an access point, the computer-executable instructions performing steps comprising:
receiving, from the computing device, a probe request comprising a request for authentication information;
generating a probe response comprising authentication information associated with the access point; and
transmitting the generated probe response to the computing device in response to the receiving the probe request from the computing device.

10. The computer-readable media of claim 9, comprising further computer-executable instructions for validating the request for authentication information; wherein the transmitting is only performed if the request for authentication information is validated.

11. The computer-readable media of claim 10, wherein the validating is performed with reference to a blacklist of computing devices which are to be prevented from establishing a useful communicational connection with the access point, the useful communication connection providing for communications with other computing devices through the access point.

12. The computer-readable media of claim 9, comprising further computer-executable instructions for encrypting the authentication information associated with the access point; wherein the authentication information associated with the access point that is part of the generated probe response is the encrypted authentication information associated with the access point.

13. The computer-readable media of claim 12, wherein the encrypted authentication information associated with the access point is decryptable by a user-specific key.

14. The computer-readable media of claim 12, wherein the encrypted authentication information associated with the access point is decryptable by an application-specific key associated with an application program.

15. The computer-readable media of claim 14, wherein the application program provides advertising on behalf of a retailer hosting the access point.

16. A wireless communication system providing for autoconnection of one or more computing devices, the system comprising:
a wireless access point to which the one or more computing devices can autoconnect, the wireless access point comprising computer-executable instructions performing steps comprising: receiving, from a computing device, from among the one or more computing devices, a probe request comprising a request for authentication information; generating a probe response comprising authentication information associated with the access point; and transmitting the generated probe response to the computing device in response to the receiving the probe request from the computing device; and
an application program for execution on the one or more computing devices, the application program comprising computer-executable instructions performing steps comprising: generating the probe request; transmitting the generated probe request in response to detecting the access point; receiving, from the access point, the generated probe response, in response to the transmitting the generated probe request; generating a request to establish a useful communicational connection with the access point, the useful communication connection providing for communications with other computing devices through the access point, the generated request comprising the authentication information associated with the access point from the received probe response; and transmitting the generated request to the access point.

17. The system of claim 16, wherein the application program provides advertising on behalf of a retailer hosting the access point.

18. The system of claim 16, wherein the wireless access point further comprises computer-executable instructions for encrypting the authentication information associated with the access point; wherein the authentication information associated with the access point that is part of the generated probe response is the encrypted authentication information associated with the access point; and wherein the application program further comprises an application-specific key associated with the application program and computer-executable instructions for decrypting the encrypted authentication information associated with the access point with the application-specific key.

19. The system of claim 16, wherein the probe request comprises at least one information element, the at least one information element of the generated probe request comprising the request for authentication information; and wherein further the probe response also comprises at least one information element, the at least one information element of the received probe response comprising the authentication information associated with the access point.

20. The system of claim 16, wherein the wireless access point further comprises computer-executable instructions for validating the request for authentication information; wherein the transmitting is only performed if the request for authentication information is validated.
